(19) United States
(12) Patent Application Publication
(10) Pub. No.: US 2012/0143981 A1
(43) Pub. Date: Jun. 7, 2012

(54) COMMON SERVER, ADAPTOR, AND DATA CONFORMING METHOD THEREOF

(75) Inventors: Cheng-Hsien KU, Xindian City (TW); Chiung-Fang Tsao, Taipei City (TW)

(73) Assignee: INSTITUTE FOR INFORMATION INDUSTRY, Taipei (TW)

(21) Appl. No.: 12/967,835

(22) Filed: Dec. 14, 2010

(30) Foreign Application Priority Data
Dec. 2, 2010 (TW) 099141888

(51) Int. Cl. G06F 15/16

(52) U.S. Cl. 709/217

(57) ABSTRACT

A common server, an adaptor, and a data conforming method thereof are provided. The adaptor connects to sensor network system. The sensor network system connects to the common server via the adaptor through a network. Different sensor network systems can transform the data via the adaptor connected thereto to make different data conform with a common parameter format. After receiving different data, which conform to the common parameter format, from the different sensor networks, the common server transmits the data to the back-end application server accordingly so that the data can be processed.

This application claims priority to Taiwan Patent Application No. 099141888 filed on Dec. 2, 2010, which is hereby incorporated by reference in its entirety

### FIELD

The present invention relates to a common server, an adaptor, and a data conforming method thereof. More particularly, the common server, the adaptor, and the data conforming method thereof of the present invention can conform data of different sensor network systems so that the data are processed by a back-end application server.

### BACKGROUND

Sensor networks play an important role in development of the modern networks, and can be used for high-density sensing in specific environments owing to their advantage of low deployment cost. Accordingly, sensor networks for various applications, for example, smart building sensor networks and advanced metering infrastructure sensor networks, have thus been developed.

However, because the sensor networks are mostly customized, it becomes much difficult to conform data at the back end and develop corresponding applications due to their heterogeneity. For example, when it is desired to integrate a smart building sensor network and an advanced metering infrastructure sensor network into an internet of things, significant difference between formats of data sensed by the two networks necessitates use of different sensing servers for transforming the output data of the two networks respectively. After being transformed, the data are then transmitted to a back-end application server so that the data are used and processed by the back-end application server.

Further speaking, in the aforesaid framework of the internet of things, in addition to deployment of different sensing servers for different sensor networks, the back-end application server also has to be provided with different network adaptor interfaces for the different sensing servers in order to receive the transformed data transmitted by the different sensing servers. Thus, deployment flexibility and operating efficiency of the internet of things are significantly reduced while the cost is increased.

Accordingly, an urgent need exists in the art to provide a solution that can integrate different sensor network systems in an internet of things to achieve high flexibility, high efficiency and low cost of the internet of things.

### SUMMARY

To solve the aforesaid problem of lacking conformability, an objective of the present invention is to provide a common server, an adaptor and a data conforming method thereof. The adaptor connects to a sensor network system, and the sensor network system connects with the common server via a network through the adaptor. The primary objective of this is that, different sensor network systems can transform data through the adaptor connected thereto so that outputs of the different sensor network systems conform to a common parameter format. The common server can, after receiving the outputs conforming to the common parameter format, conform and transmit the outputs to a back-end application server so that subsequent processing can be made on the data.

To achieve the aforesaid objective, the present invention provides a data conforming method for a common server. The common server connects with at least two sensor network systems and an application server via a network, and the at least two sensor network systems comprise a first sensor network system and a second sensor network system. The data conforming method comprises the following steps of: (a) enabling the common server to receive a first common data from a first adaptor of the first sensor network system and a second common data from a second adaptor of the second sensor network system, wherein the first common data and the second common data conform to a common parameter format; (b) enabling the common server to record in a common database the first common data and the second common data conforming to the common parameter format; and (c) enabling the common server to transmit to the application server the first common data and the second common data that are stored in the common database and conform to the common parameter format.

To achieve the aforesaid objective, the present invention further provides a common server for conforming data, which connects with at least two sensor network systems and an application server via a network. The at least two sensor network systems comprise a first sensor network system and a second sensor network system. The server comprises a common adaptor module, a logical control module and an observation service module. The common adaptor module is configured to receive a first common data from a first adaptor of the first sensor network system and a second common data from a second adaptor of the second sensor network system. The first common data and the second common data conform to a common parameter format. The logical control module is configured to record in a common database the first common data and the second common data conforming to the common parameter format. The observation service module is configured to transmit to the application server the first common data and the second common data that are stored in the common database and conform to the common parameter format.

To achieve the aforesaid objective, the present invention further provides a data conforming method for an adaptor. The adaptor connects to a sensor network system, and the sensor network system connects with a common server via a network through the adaptor. The data conforming method comprises the following steps of: (a) enabling the adaptor to retrieve a sense data from the sensor network system; (b) enabling the adaptor to transform the sense data into a common data according to a common parameter format; and (c) enabling the adaptor to transmit the common data to the common server.

To achieve the aforesaid objective, the present invention further provides an adaptor for conforming data. The adaptor connects to a sensor network system. The sensor network system connects with a common server via a network through the adaptor. The adaptor comprises a coding module and a transaction module. The coding module is configured to retrieve a sense data from the sensor network system and transform the sense data into a common data according to a common parameter format. The transaction module is configured to transmit the common data to the common server.

With the technical features disclosed above, the common server, the adaptor and the data conforming method thereof of the present invention can conform data according to a common parameter setting so that the data can be processed by a back-end application server.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an internet of things of a first embodiment of the present invention;

FIG. 1B is a schematic view of a first adaptor of the first embodiment of the present invention;

FIG. 1C is a schematic view of a second adaptor of the first embodiment of the present invention;

FIG. 1D is a schematic view of a common server of the first embodiment of the present invention;

FIG. 1E is a schematic view of a common parameter format of the first embodiment of the present invention;

FIG. 2A is a schematic view of an internet of things of a second embodiment of the present invention;

FIG. 2B is a schematic view of a third adaptor of the second embodiment of the present invention;

FIG. 3 is a flowchart of a data conforming method of a third embodiment of the present invention; and

FIG. 4 is a flowchart of a data conforming method of a fourth embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements not directly related to the present invention are omitted from depiction.

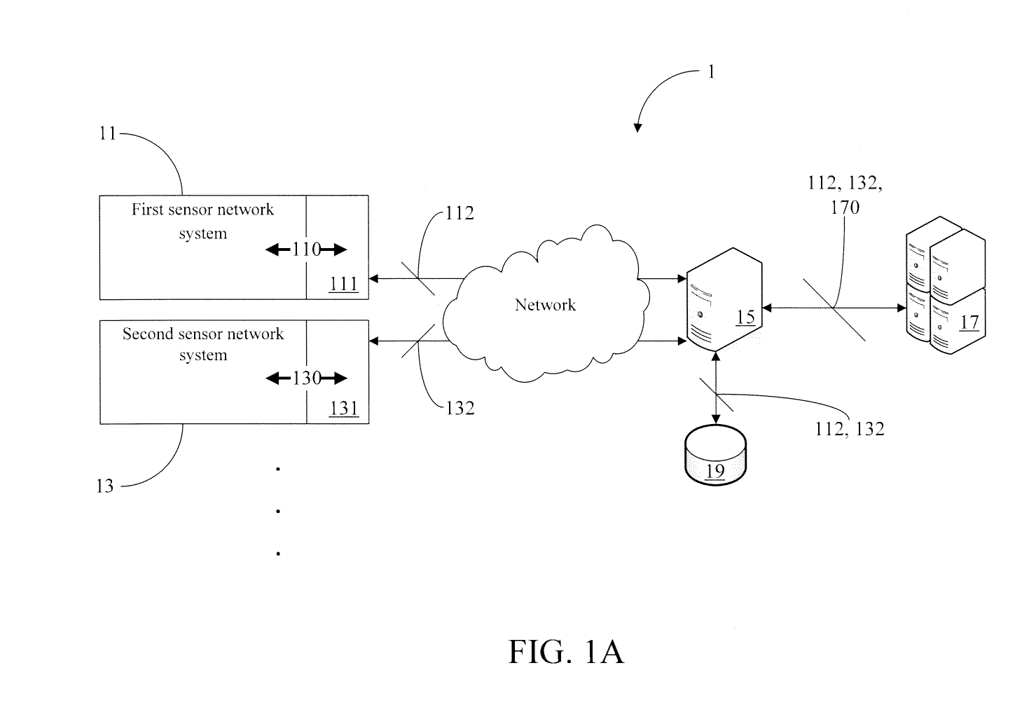

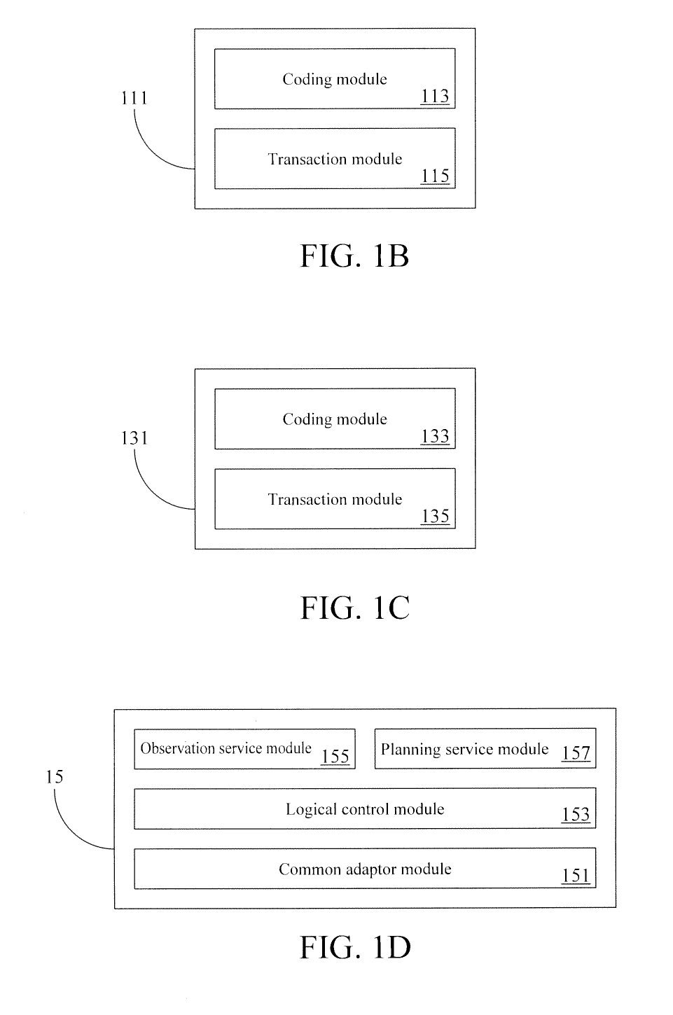

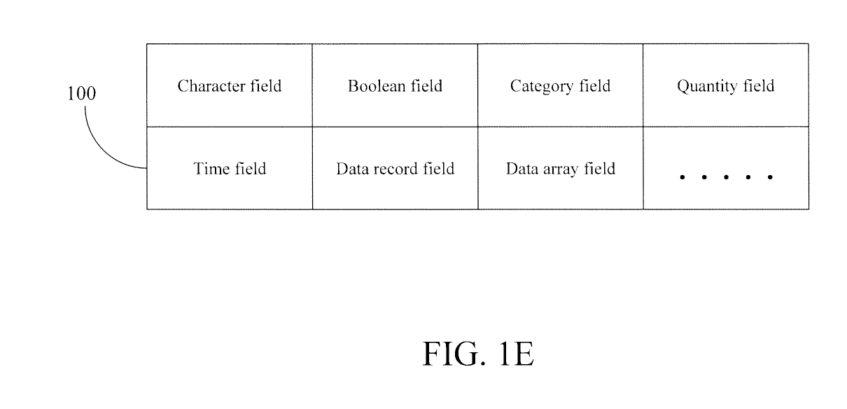

Firstly, referring to FIG. 1A, there is shown a schematic view of an internet of things 1 according to a first embodiment of the present invention. The internet of things 1 comprises at least two sensor network systems, a common server 15, an application server 17 and a common database 19. The at least two sensor network systems comprise a first sensor network system 11 and a second sensor network system 13. It shall be particularly emphasized that, the at least two sensor network systems may be various kinds of sensor networks, for example, various existing sensor networks such as wireless sensor networks (WSNs), smart building sensor networks or advanced metering infrastructure sensor networks. The common database 19 is an external database in the first embodiment; however, in other examples, the common database 19 may also be a built-in database of the common server 15.

Next, referring to FIG. 1B to FIG. 1D together, there are depicted hardware architectures of a first adaptor 111, a second adaptor 131 and the common server 15 respectively. As depicted in FIG. 1B, the first adaptor 111 comprises a coding module 113 and a transaction module 115. As depicted in FIG. 1C, the second adaptor 131 comprises a coding module 133 and a transaction module 135. As depicted in FIG. 1D, the common server 15 comprises a common adaptor module 151, a logical control module 153, an observation service module 155 and a planning service module 157. Functions of and interactions between these hardware modules will be described in detail hereinafter.

Referring back to FIG. 1A, in the first embodiment, the common server 15 connects with the first sensor network system 11, the second sensor network system 13 and the application server 17 via a network. The first sensor network system 11 connects with the common server 15 through the first adaptor 111, and the second sensor network system 13 connects with the common server 15 through the second adaptor 131.

Referring to FIG. 1E together, there is depicted a schematic view of a common parameter format 100 according to the first embodiment of the present invention. It shall be particularly appreciated that, in the first embodiment, the common parameter format 100 defines a character field, a boolean field, a category field, a quantity field, a time field, a data record field and a data array field; however, these fields are only provided for ease of understanding, but are not intended to limit the common parameter format of the present invention to a fixed format.

Next, please refer back to FIG. 1A. Specifically, the first sensor network system 11 generates a first sense data 110 when performing detection in an environment where it is located. Then, the coding module 113 of the first adaptor 111 retrieves the first sense data 110 from the first sensor network 11. The first sense data 110 has a format of a customized data structure, so in order for ease of subsequent conformation, the coding module 113 of the first adaptor 111 transforms the first sense data 110 into a first common data 112 conforming to the common parameter format 100 according to the content of the common parameter format 100. After the data transformation, the transaction module 115 of the first adaptor 111 transmits the first common data 112 to the common server 15.

Similarly, the second sensor network system 13 generates a second sense data 130 when performing detection in an environment where it is located. Then, the coding module 133 of the second adaptor 131 retrieves the second sense data 130 from the second sensor network 13. Similarly, the second sense data 130 has a format of a customized data structure, so in order for ease of subsequent conformation, the coding module 133 of the second adaptor 131 transforms the second sense data 130 into a second common data 132 conforming to the common parameter format 100 according to the content of the common parameter format 100. After the data transformation, the transaction module 135 of the second adaptor 131 transmits the second common data 132 to the common server 15.

In other words, the common adaptor module 151 of the common server 15 receives the first common data 112 conforming to the common parameter format 100 from the first adaptor 111 of the first sensor network 11 and the second common data 132 conforming to the common parameter format 100 from the second adaptor 131 of the second sensor network 13. Then, the logical control module 153 of the common server 15 records the first common data 112 and the second common data 132, which conform to the common parameter format 100, into the common database 19 so that subsequent processing is performed on the data.

Because the first common data 112 and the second common data 132 transmitted from the first sensor network system 11 and the second sensor network system 13, which are different from each other, respectively have been conformed, the common server 15 can transmit the data directly through a fixed interface to the back-end application server 17 for processing and analysis. Specifically, when the common server 15 is to transmit the first common data 112 and the second common data 132 stored in the common database 19 to the application server 17, the common server 15 needs only a single interface (i.e., the observation service module 155) to transmit the first common data 112 and the second common data 132 conforming to the common parameter format 100 from the common database 19 to the application server 17 so as to process the data sensed by the sensor network systems.

On the other hand, with the network architecture of the present invention, the application server 17 can also control the sensor network systems. Specifically, when the application server 17 is to operate the at least two sensor network systems, the application server 17 firstly transmits an application control signal 170 to the planning service module 157 of the common server 15. In other words, after the application control signal 170 is received by the planning service module 157 of the common server 15, the common server 15 transmits the application control signal to one of the at least two sensor network systems by means of the common adaptor module.

Taking the first sensor network system 11 as an example, when the application server 17 is to manipulate a sensor of the first sensor network system 11, the application server 17 can transmit the application control signal 170 to the first adaptor 111 of the first sensor network system 11 through the aforesaid steps. After the application control signal 170 is received by the transaction module 115 of the first adaptor 111, the coding module 113 of the first adaptor 111 transforms the application control signal 170 into a first sensor network control signal, which is subsequently transmitted to the first sensor network system 11 to control the first sensor network system 11.

With the arrangement of the first adaptor 111, the second adaptor 131 and the common server 15 of the aforesaid first embodiment, the heterogeneous sense data detected by the first sensor network system 11 and the second sensor network system 13 can be further conformed efficiently so as to be analyzed and processed subsequently by the application server 17. Moreover, with the network architecture of the first embodiment, the application server 17 can also manipulate the sensor network systems.

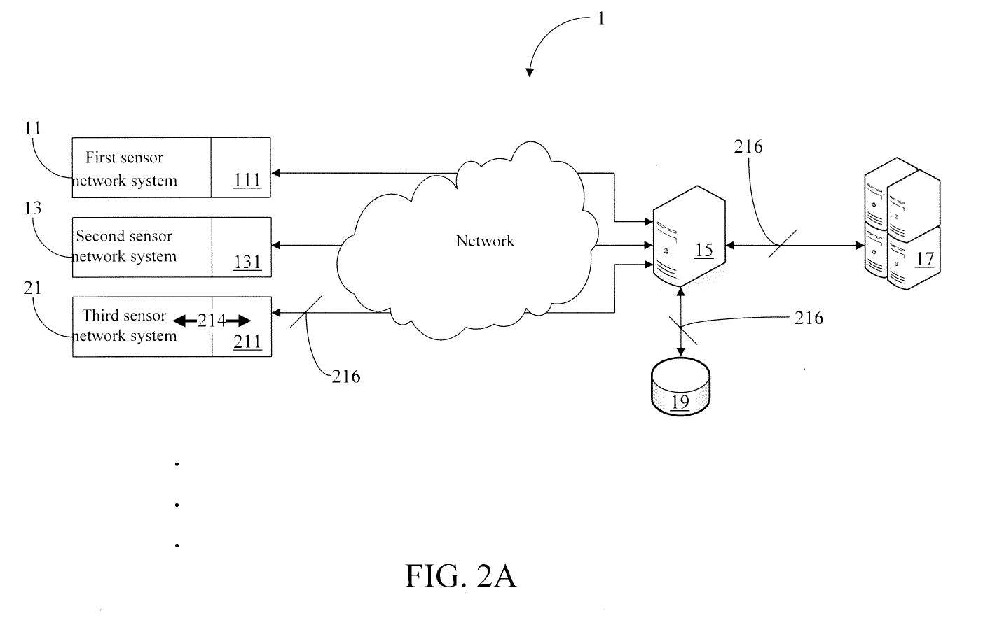

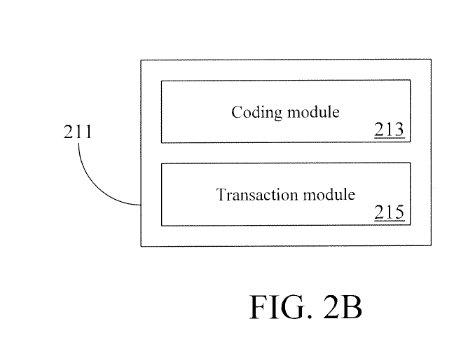

Next, referring to FIG. 2A, a schematic view of a second embodiment of the present invention is shown therein. It shall be firstly appreciated that, the approach to conform data in the second embodiment is identical to that described in the first embodiment, and elements with the same reference numbers also have the same functions, so no further description will be made thereon. Hereinbelow, an example of adding a sensor network system to the internet of things 1 will be described in the second embodiment.

Specifically, a third sensor network system 21, when being to join in the internet of things 1, firstly needs to update the data format sensed by a sensor thereof with the common server 15 synchronously. In more detail, referring to FIG. 2B together, firstly, a transaction module 213 of a third adaptor 211 retrieves an initial format data 210 from the third sensor network system 21. Next, the transaction module 213 of the third adaptor 211 performs an initial connection 212 (represented by a dashed line) with the common server 15; in other words, the common adaptor module 151 of the common server 15 establishes the initial connection 212 with the third sensor network system 21 through the third adaptor 211.

After the initial connection 212 is established, the third adaptor 211 transmits the initial format data 210 of the third sensor network system 21 to the common server 15 via the initial connection 212. In other words, the common adaptor module 151 of the common server 15 receives the initial format data 210 from the third adaptor 211 via the initial connection 212. Then, the logical control module 153 of the common server 15 updates the common parameter format 100 according to the initial format data 210.

Through updating the common parameter format, the data format to be subsequently transmitted by the third sensor network system 21 will become acceptable to the common server 15 so that subsequent processing can be made by the application server 17. Referring to FIG. 2C, there is shown a schematic view of data transmission after the third sensor network system 21 joins in the internet of things 1. Similarly, the third sensor network system 21, when performing detection in an environment where it is located, generates a third sense data 214; and then, the coding module 213 of the third adaptor 211 retrieves the third sense data 214 from the third sensor network system 21. Because the data of the third sensor network system 21 has been synchronized to the common parameter format 100, the format of the third sense data 214 can be conformed subsequently. Further speaking, the coding module 213 of the third adaptor 211 transforms the third sensor data 214 into a third common data 216 conforming to the common parameter format 100 according to the content of the common parameter format 100. After the data transformation, the transaction module 215 of the third adaptor 211 transmits the third common data 216 to the common server 15.

In other words, the common adaptor module 151 of the common server 15 receives the third common data 216 conforming to the common parameter format 100 from the third adaptor 211 of the third sensor network system 21. Then, the logical control module 153 of the common server 15 records in the common database 19 the third common data 216 conforming to the common parameter format 100 so that the data can be processed subsequently.

Because the third common data 216 has been conformed, the common server 15 can transmit the data directly through a fixed interface to the back-end application server 17 for processing and analysis. Specifically, when the common server 15 is to transmit the third common data 216 stored in the common database 19 to the application server 17, the common server 15 needs only a single interface (i.e., the observation service module 155) to transmit the third common data 216 conforming to the common parameter format 100 from the common database 19 to the application server 17 so as to process the data sensed by the sensor network system.

Thus, in the way described in the aforesaid second embodiment, the internet of things 1 can be added with any heterogeneous sensor network system (e.g., the third sensor network system 21) flexibly whenever necessary and, meanwhile, correct operation of the interne of things 1 is ensured.

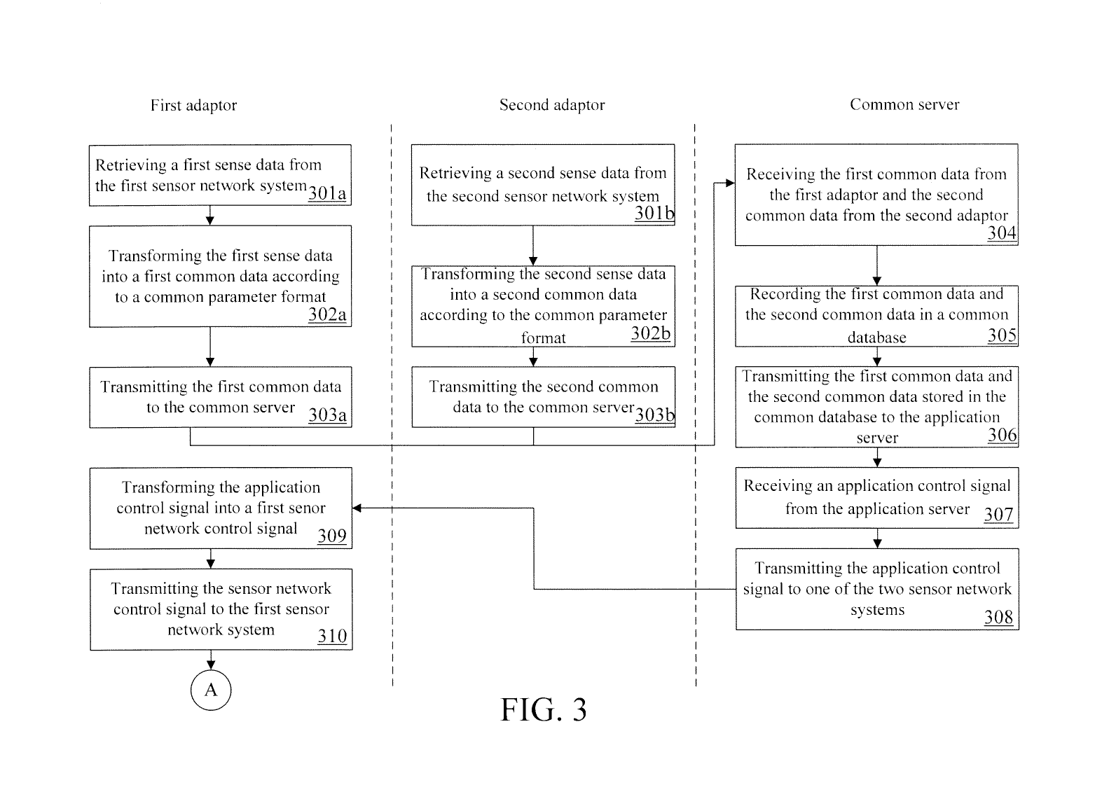

A third embodiment of the present invention is a data conforming method, a flowchart of which is shown in FIG. 3. The method of the third embodiment is used in a common server of an internet of things and adaptors of at least two sensor network systems. The common server connects with the at least two sensor network systems and an application server via a network. The at least two sensor network systems comprise a first sensor network system having a first adaptor and a second sensor network system having a second adaptor. The first adaptor, the second adaptor and the common server may be the first adaptor 111, the second adaptor 131 and the common server 15 of the aforesaid embodiment. Detailed steps of the third embodiment will be described below.

Step 301a is executed to enable the first adaptor to retrieve a first sense data from the first sensor network system. Step 302a is executed to enable the first adaptor to transform the first sense data into a first common data according to a common parameter format. Step 303a is executed to enable the first adaptor to transmit the first common data to the common server. At the same point, step 301b is executed to enable the second adaptor to retrieve a second sense data from the second sensor network system. Step 302b is executed to enable the second adaptor to transform the second sense data into a second common data according to the common parameter format. Step 303b is executed to enable the second adaptor to transmit the second common data to the common server.

Next, step 304 is executed to enable the common server to receive the first common data from the first adaptor of the first sensor network system and the second common data from the second adaptor of the second sensor network system. The first common data and the second common data have already conformed to the common parameter format. Step 305 is executed to enable the common server to record in a common database the first common data and the second common data conforming to the common parameter format. Step 306 is executed to enable the common server to transmit the first common data and the second common data, which are stored in the common database and conform to the common parameter format, to the application server.

Then, step 307 is executed to enable the common server to receive an application control signal from the application server. Step 308 is executed to enable the common server to transmit the application control signal to the adaptor of one of the at least two sensor network systems, i.e., to one of the first sensor network system and the second sensor network system. In the third embodiment, the application control signal is transmitted to the first adaptor of the first sensor network system; however, it is not intended to limit the present invention. Step 309 is executed to enable the first adaptor to transform the application control signal into a first sensor network control signal, and step 310 is executed to enable the first adaptor to transmit the first sensor network control signal to the first sensor network system so that the first sensor network system performs operation of the sensor.

With the method of the aforesaid third embodiment, the heterogeneous sense data detected by the sensor network systems can be further conformed efficiently so as to be analyzed and processed subsequently by the application server. Moreover, the application server can also manipulate the sensor network system.

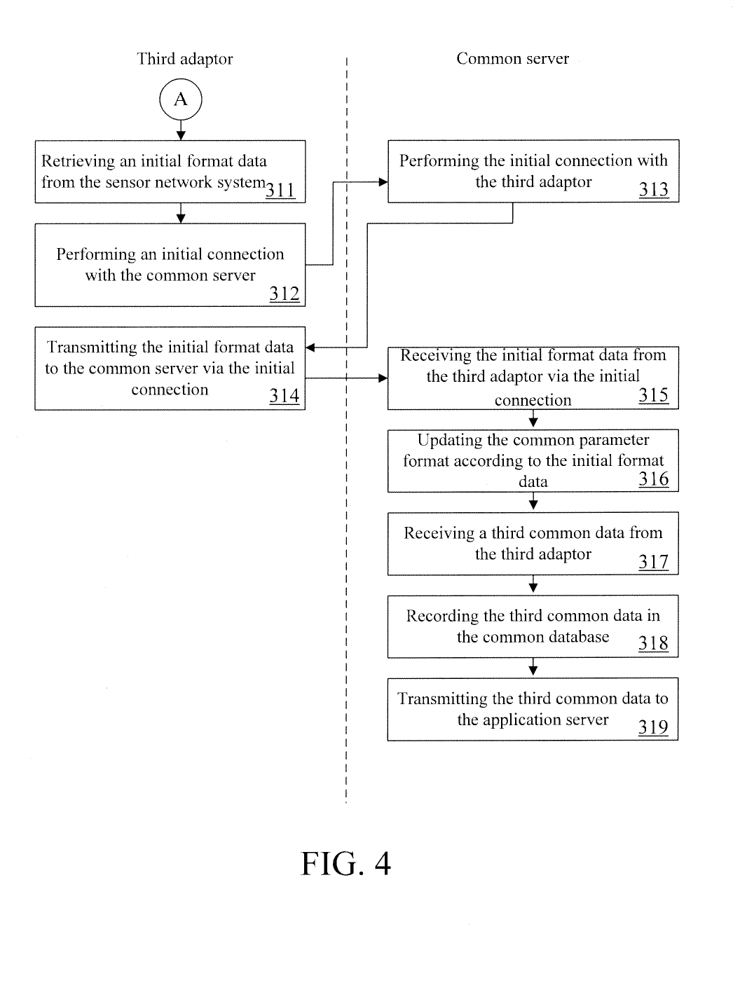

A fourth embodiment of the present invention is a data conforming method, a flowchart of which is shown in FIG. 4. It shall be particularly appreciated that, in the fourth embodiment, the flow process of conforming data and elements are identical to those of the third embodiment, and thus no further description will be made thereon. Hereinbelow, an example of adding a sensor network system will be described in the fourth embodiment of the present invention.

Specifically, the internet of things further comprises a third sensor network system to be added therein, and the third network system has a third adaptor. Then, step 311 is executed to enable the third adaptor to retrieve an initial format data from the third sensor network system. Step 312 is executed to enable the third adaptor to perform an initial connection with the common server. In other words, step 313 is executed to enable the common server to perform the initial connection with the third adaptor of the third sensor network system.

Step 314 is executed to enable the third adaptor to transmit the initial format data to the common server via the initial connection. In other words, step 315 is executed to enable the common server to receive the initial format data from the third adaptor of the third sensor network system via the initial connection. Step 316 is executed to enable the common server to update the common parameter format according to the initial format data.

Through the aforesaid process, the third sensor network system can transmit data in the internet of things. Specifically, step 317 is then executed to enable the common server to receive a third common data from the third adaptor of the third sensor network system, wherein the third common data conforms to the common parameter format. Step 318 is executed to enable the common server to record in the common database the third common data conforming to the common parameter format.

Thus, through the method of the aforesaid third embodiment, the internet of things can be added with any heterogeneous sensor network system (e.g., the third sensor network system) flexibly whenever necessary and, meanwhile, correct operation of the internet of things can be ensured.

According to the above descriptions, the common server, the adaptor and the data conforming method thereof of the present invention can conform data efficiently according to a common parameter setting and can be added with more heterogeneous sensor network systems flexibly so that the data can be processed by the back-end application server.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data conforming method for a common server, the common server connecting with at least two sensor network systems and an application server via a network, and the at least two sensor network systems comprising a first sensor network system and a second sensor network system, the data conforming method comprising the following steps of:
(a) enabling the common server to receive a first common data from a first adaptor of the first sensor network system and a second common data from a second adaptor of the second sensor network system, wherein the first common data and the second common data conform to a common parameter format;
(b) enabling the common server to record the first common data and the second common data, which conform to the common parameter format, in a common database; and
(c) enabling the common server to transmit the first common data and the second common data, which are stored in the common database and conform to the common parameter format, to the application server.

2. The data conforming method as claimed in claim 1, further comprising the following steps of:
(d) enabling the common server to receive an application control signal from the application server; and
(e) enabling the common server to transmit the application control signal to one of the at least two sensor network systems.

3. The data conforming method as claimed in claim 1, further comprising the following steps of:
(d) enabling the common server to set up an initial connection with a third adaptor of a third sensor network system;
(e) enabling the common server to receive an initial format data from the third adaptor of the third sensor network system via the initial connection; and
(f) enabling the common server to update the common parameter format according to the initial format data.

4. The data conforming method as claimed in claim 3, further comprising the following steps subsequent to the step (f):
(g) enabling the common server to receive a third common data from the third adaptor of the third sensor network system, wherein the third common data conforms to the common parameter format;
(h) enabling the common server to record the third common data, which conforms to the common parameter format, in the common database; and
(i) enabling the common server to transmit the third common data, which is stored in the common database and conforms to the common parameter format, to the application server.

5. The data conforming method as claimed in claim 1 wherein the common parameter format defines a character field, a boolean field, a category field, a quantity field, a time field, a data record field and a data array field.

6. A common server for conforming data, the common server connecting with at least two sensor network systems and an application server via a network, the at least two sensor network systems comprising a first sensor network system and a second sensor network system, the common server comprising:
a common adaptor module, being configured to receive a first common data from a first adaptor of the first sensor network system and a second common data from a second adaptor of the second sensor network system, wherein the first common data and the second common data conform to a common parameter format;
a logical control module, being configured to record the first common data and the second common data, which conform to the common parameter format, in a common database; and
an observation service module, being configured to transmit the first common data and the second common data, which are stored in the common database and conform to the common parameter format, to the application server.

7. The common server as claimed in claim 6, further comprising:
a planning service module, being configured to receive a sensor network control signal from the application server, and transmit the sensor network control signal to one of the at least two sensor network systems via the common adaptor module.

8. The common server as claimed in claim 6, wherein the common adaptor module is further configured to set up an initial connection with a third sensor network system and receive an initial format data from a third adaptor of the third sensor network system via the initial connection, and the logical control module is further configured to update the common parameter format according to the initial format data.

9. The common server as claimed in claim 8, wherein the common adaptor module is further configured to receive a third data from the third adaptor of the third sensor network system, the third data conforms to the common parameter format, the logical control module is further configured to record the third data, which conforms to the common parameter format, in the common database, and the observation service module is further configured to transmit the third data, which is stored in the common database and conforms to the common parameter format, to the application server.

10. The common server as claimed in claim 6, wherein the common parameter format defines a character field, a boolean field, a category field, a quantity field, a time field, a data record field and a data array field.

11. A data conforming method for an adaptor, the adaptor connecting to a sensor network system, and the sensor network system connecting with a common server via a network through the adaptor, the data conforming method comprising the following steps of:
(a) enabling the adaptor to retrieve a sense data from the sensor network system;
(b) enabling the adaptor to transform the sense data into a common data according to a common parameter format; and
(c) enabling the adaptor to transmit the common data to the common server.

12. The data conforming method as claimed in claim 11, further comprising the following steps of:
(d) enabling the adaptor to receive an application control signal transmitted from the common server by an application server;
(e) enabling the adaptor to transform the application control signal into a sensor network control signal; and
(f) enabling the adaptor to transmit the sensor network control signal to the sensor network system.

13. The data conforming method as claimed in claim 11, further comprising the following steps before the step (a):
(a1) enabling the adaptor to retrieve an initial format data from the sensor network system;
(a2) enabling the adaptor to set up an initial connection with the common server; and
(a3) enabling the adaptor to transmit the initial format data to the common server via the initial connection so that the common server updates the common parameter format according to the initial format data.

14. The data conforming method as claimed in claim 11, wherein the common parameter format defines a character field, a boolean field, a category field, a quantity field, a time field, a data record field and a data array field.

15. An adaptor for conforming data, the adaptor connecting to a sensor network system, and the sensor network system connecting with a common server via a network through the adaptor, the adaptor comprising:
a coding module, being configured to retrieve a sense data from the sensor network system and transform the sense data into a common data according to a common parameter format; and
a transaction module, being configured to transmit the common data to the common server.

16. The adaptor as claimed in claim 15, wherein the transaction module is further configured to receive an application control signal, which is transmitted by an application server, from the common server and the coding module is further configured to transform the application control signal into a sensor network control signal and transmit the sensor network control signal to the sensor network system.

17. The adaptor as claimed in claim 15, wherein the transaction module is further configured to retrieve an initial format data from the sensor network system, set up an initial connection with the common server, and transmit the initial format data to the common server via the initial connection so that the common server updates the common parameter format according to the initial format data.

18. The adaptor as claimed in claim 15, wherein the common parameter format defines a character field, a boolean field, a category field, a quantity field, a time field, a data record field and a data array field.
